(19) United States
(12) Patent Application Publication
(10) Pub. No.: US 2005/0119769 A1
(43) Pub. Date: Jun. 2, 2005

(54) Method for assisting suggestions aimed at improving at least part of parameters controlling a system with several input parameters

(76) Inventor: Christophe Labreuche, Antony (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/499,717

(22) PCT Filed: Dec. 17, 2002
(86) PCT No.: PCT/FR02/04401

(30) Foreign Application Priority Data
Dec. 21, 2001 (FR) 01/16698

(51) Int. Cl. G05B 13/02

(52) U.S. Cl. 700/52; 700/53; 700/30; 700/31

(57) ABSTRACT

The process of the invention consists in determining a model which contains the partial criteria for evaluating a student, and represents the degree of satisfaction, in aggregating these partial criteria so as to be able to express an overall degree of satisfaction, in evaluating the student and in highlighting the weak points to be improved through action on at least part of the parameters.

The present invention relates to a process for aiding the proposal of improvements to at least part of the parameters governing a system with several input parameters.

An example of such a system may be a training simulator. Such a system has to include a pedagogic aid function. An important aspect of the consequent pedagogy is “debriefing”, that is to say the analysis of a student's results on completion of an exercise session on a training simulator. The problem is to present the students finishing a simulator exercise with an analysis of their performance by showing them their weak points (which will enable them to progress) and strong points (which is a psychological stimulant). The underlying idea is to optimize the training schedule so as to reduce the cost of training the students.

Within the framework of the applications mentioned above, the students should have their strong points and weak points indicated on completion of an exercise. The indications provided should enable them to progress as effectively as possible. The problem which arises is then as follows: how to integrate the expertise of the instructors so as to analyze an exercise and provide this information to the students?

A certain number of technologies in the field of artificial intelligence deal with this problem:
Expert systems. Expert systems are developed to solve this type of problem. The expert system compares the sequence of actions performed by the student with what an expert would have done, and presents the errors to the student. Expert systems are based on a sequential analysis of the exercise. This is not always desirable. The question of determining the rules of the expert system poses a problem.
Fuzzy logic. Fuzzy logic has been applied time and time again, especially in Japan. It is far from easy to obtain the fuzzy rules, and numerous problems exist.
Decision trees. Decision trees are used a great deal, especially in classification. They may become very complex and lose all readability. They therefore exhibit the same drawbacks as neural networks.

In the existing technologies, expertise is often modeled in the form of rules. The exercise is then often seen as a sequence of actions to be carried out. With these technologies, an essential aspect is not taken into account: the multicriterion aspect of the problem. Specifically, several decision criteria have to be taken into account to provide debriefing to the students. The difficulty is that these criteria interact with one another in a complex manner. Certain criteria are antagonistic, others are complementary. The existing technologies do not enable these phenomena to be modeled.

The existing technologies generally require direct modeling of the expertise relating to the debriefing to be provided to the students.

The process of the invention consists in determining a model which contains the partial criteria for evaluating a student, and represents the degree of satisfaction, in aggregating these partial criteria so as to be able to express an overall degree of satisfaction, in evaluating the student and in highlighting the weak points to be improved through action on at least part of the parameters.

The present invention will be better understood on reading the detailed description of a mode of implementation, taken by way of nonlimiting example and illustrated by the appended drawing, in which:

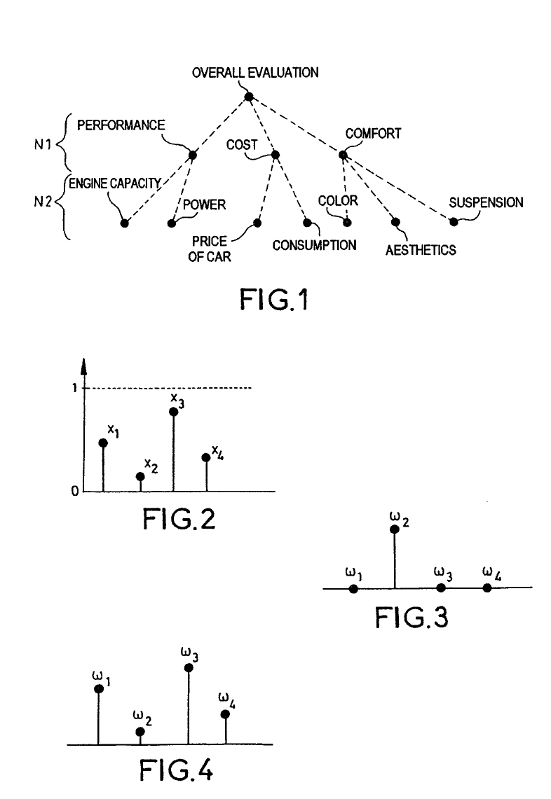

FIG. 1 is a simplified diagram showing the way to obtain, according to the invention, an overall indicator,

FIG. 2 is a simplified diagram of the scores obtained by a student, and

FIGS. 3 and 4 are diagrams of criteria relating to the student depicted in FIG. 1, respectively in the case of an intolerant supervisor and of a tolerant supervisor.

The present invention is described hereinbelow with reference to a student who is following advancement sessions on a training simulator (automobile driving or aircraft piloting simulator, etc.), but it is of course understood that the invention is not limited to this application alone, and that it may be implemented in numerous other fields, not only pedagogic fields, but in any field in which a system is governed by several input criteria which determine a result, it being possible for this result to be improved or optimized after analyzing its grading, it being possible for the improvement to be greater or lesser depending on whether one acts selectively on certain of the parameters (or on the whole set of parameters), the choice of parameters on which it is possible to act being dictated, among other things, by the effectiveness regarding the degree of improvement. An example of such fields may be a process for manufacturing products in respect of which the buyers manifest a degree of satisfaction that the manufacturer seeks to improve substantially with the minimum possible effort.

In the case of a pedagogic system, the invention consists in gathering the expertise required to answer the problem. Instead of directly modeling the debriefing to be provided to the students, the invention models the expert's preferences as regards the alternatives (the students). This is done through multicriterion decision theory. This involves modeling the preference relation denoted φ that the experts (the instructors) may have regarding the alternatives. The multicriterion aspect stems from the fact that the alternatives are described by various points of view to be taken into account. More precisely, the invention proposes to use multiattribute utility theory (R. L. Keeney and H. Raiffa, “Decision with Multiple Objectives”, Wiley, New York, 1976). This involves modeling the preference relation regarding the results of the students by an overall utility (overall score):
x≧yU(x)≧U(y)

With each alternative x, is therefore associated an overall utility U(x) which represents the degree of preference that the expert accords x. The second step consists in providing the student with the debriefing. By analyzing the expression for the “overall cost” function U, one deduces therefrom what a student x ought to do in order to progress as well as possible.

To describe multiattribute utility theory, let us assume that there are n points of view X₁, . . . , Xₙ describing the various aspects to be taken into account to evaluate a student. The overall utility function U is taken in the following form:
U(x)=H(u₁)(x₁), . . . , uₙ(xₙ))
where H is the aggregation function and the uᵢ are the utility functions. The n points of view being given in different measurement units, the utility functions serve to go to a single commensurability scale C. The utility functions therefore serve to be able to compare given values in accordance with various points of view. The scale C is an interval of the set of reals (typically C=[0,1]). The number uᵢ(xᵢ) corresponds to the degree of satisfaction that the expert accords to alternative x relating solely to point of view Xᵢ. The aggregation function H therefore aggregates the degrees of satisfaction of an alternative in accordance with the various points of view, and returns the overall degree of satisfaction.

The problem of multicriteria aggregation consists in summarizing information representing different aspects or points of view which may sometimes conflict as regards a set of objects. It arises in a crucial manner in industrial systems, in particular in the form of multicriteria decision problems. It is then characterized by the construction of a family of n real-valued criteria functions (the utility functions uᵢ), making it possible to evaluate the performance ratings (or degrees of satisfaction) of the various actions according to each of the points of view. The performance ratings of an action in accordance with the various criteria are then aggregated via H.

The description above relates to the case where the points of view are aggregated at the same level. Nevertheless, when the number of points of view becomes fairly significant, in practice we effect several levels of aggregation in cascade.

To fully determine the model, the invention implements the following three phases:
Phase 1: hierarchization of the criteria. This involves determining the points of view to be taken into account and their hierarchization in tree form. The methodologies making it possible to do this are known and are based on the use of cognitive maps (C. Eden, “Cognitive mapping”, Europ. J. of Operational Research, 36, pp. 1-13, 1988). Certain software packages such as COPE are aimed at aiding the decision maker to bring the pertinent criteria to the fore.
Phase 2: formalization of the criteria. A certain number of software packages make it possible to determine the utility functions uᵢ (Expert Choice, Criterium Decision Plus, MACBETH poids).
Phase 3: determination of the aggregation function: numerous software packages and techniques implement the construction of the aggregation function H: Expert Choice, Criterium Decision Plus, MACBETH côtes, TOPSIS, DESCRIPTOR. These tools are based on the use of a weighted sum. H is then written in the form H (u₁, . . . , uₙ)=α₁u₁+α₂u₂+ . . . +αₙuₙ, where α₁ . . . αₙ are the weights. Although this type of model is entirely conceivable in practice, it does not make it possible to model somewhat subtle decision strategies.

To alleviate this, the Choquet integral (G. Choquet, “Theory of capacities”, Annales de l'Institut Fourier, No. 3, pp. 131-295, 1953) has been introduced as aggregation function. It makes it possible to model the importance of the criteria, the interaction between criteria and the typical decision strategies such as veto, favor, tolerance and intolerance (M. Grabisch, “The application of fuzzy integrals in multicriteria decision making”, Europ. J. of Operational Research, No. 89, pp. 445-456, 1996). Several methods make it possible to determine the parameters of the Choquet integral on the basis of learning data provided by the expert: mention may be made of a heuristic method (M. Grabisch, “A new algorithm for identifying fuzzy measures and its application to pattern recignition”, in Int. Fuzzy Engineering Symposium, pp. 145-150, Yokohama, Japan, 1995), and a linear method (J. L. Marichal, M. Roubens, “Dependence between criteria and multiple criteria decision aid”, in 2^{nd} Int. Workshop on Preferences and Decisions, pp. 69-75, Trento, Italy, 1998).

The next step is an important step of the invention. Knowing U(x) is not sufficient to solve the debriefing problem. There is an action x that one wishes to modify. The aim is to modify it (modify the value of the criteria) so that this improves the overall score of the action as effectively as possible. One then seeks to maximize the “benefit to cost ratio” (the ratio of the expected benefit of the suggested improvements to the cost of the effort to be produced in order to obtain these improvements): make the smallest possible effort which best improves the overall score.

One seeks to determine the student's weak points. What the instructor is ultimately interested in is to provide the weak points to be improved, that is to say the criteria with regard to which the student should progress as a priority in order to improve as effectively as possible. When there are several aggregation levels, it is necessary to pass through the various aggregation levels to arrive at the criteria. The analysis should firstly be carried out aggregation level by aggregation level, then these partial analyses should be combined so as to deduce therefrom the weak points to be improved.

One firstly undertakes the determination of the weak points for a single aggregation level. The determination of the weak points of a student is much more complex than listing the criteria with regard to which the student has had a poor score. In fact, it depends on the manner in which the instructor judges the students overall. Let us give several examples to demonstrate this. Let us firstly consider the example of an instructor who is very intolerant in the sense that he is satisfied only if the student has good scores according to all the criteria. The aggregation function H will then correspond to the minimum: the overall score is the lowest grade among all the scores.

In this case, it is clear that the only criterion with regard to which it is beneficial for student x to improve himself is the criterion for which x has the lowest score. Let us now take an extremely tolerant instructor in the sense that he is satisfied as soon as the student has succeeded according to a single criterion. The aggregation function H will then correspond to the maximum. In this case, it is beneficial for the student x to improve himself as a priority in accordance with the criterion for which x has the highest score. As a last example of an aggregation function, let us take the case of a weighted sum. This is an extremely common way of aggregating several criteria. For this aggregation function, each criterion is independent of the others, in the sense that the contribution of a criterion to the overall score does not depend on the scores according to the other criteria. It is clear that for a weighted sum, it is beneficial for the students to work as a priority in accordance with the most important criterion (that is to say the one having the highest weight in the weighted sum). We therefore come to see that the criterion on which x should concentrate his efforts depends on the aggregation function H as well as on x itself.

In simple examples of aggregation functions, the advice to be given to the student is very simple to determine. The above examples correspond to typical, extreme, decision attitudes. The decision strategies of a decision maker lie between these extreme attitudes. Tolerance and intolerance are generally both found there. Moreover, the criteria do not all have the same importance. Under these conditions, it is not at all simple to provide the weak points to be improved as a priority.

To resolve this difficulty, the process of the invention consists in constructing an index ω_{A} which indicates the benefit to student x of improving himself in accordance with a coalition A of criteria. This notion of benefit should represent the fact that one desires a certain effectiveness in the improvements. As has been explained above, the index ω_{A} depends on the evaluation function H as well as on the student x. The benefit to student x of improving himself in accordance with the coalition A of criteria for the grading system H is denoted ω_{A}(H,x). Thus the greatest benefit to student x is to improve himself as a priority in accordance with all the criteria of the coalition A maximizing ω_{A}(H,x).

Several expressions for ω_{A}(H,x) are described hereinbelow, implementing in particular the notion of effort to be provided in order to achieve an improvement.

To explain the determination of the weak points for several levels of aggregation, let us consider, in another field, the simplified example of the evaluation of a car (see FIG. 1) broken down in the following manner: in a level N1 there are the criteria of performance, cost and comfort. These “macro-criteria” include partial criteria (in a level N2), which are respectively, in the case of performance: the engine capacity and the power, in the case of cost: the price of the car and its consumption and in the case of comfort: the color, the aesthetics of the bodywork and the quality of the suspension. If one wishes to ascertain the benefit of improving the car in accordance with the power, color and suspension criteria, it is necessary to combine the benefit in respect of the overall evaluation of improving the performance and comfort macro-criteria, the benefit in respect of the performance macro-criteria of improving the power criterion, and the benefit in respect of the comfort macro-criterion of improving the color and suspension criteria. More precisely, it is only beneficial to improve the car in accordance at one and the same time with the power, color and suspension criteria if the three benefits mentioned above are important. This leads one to define the benefit of improving the car in accordance with the power, color and suspension criteria as the minimum out of the three benefits mentioned above. The use of the “minimum” clearly conveys the fact that one wants all three benefits to be large at the same time. Stated more technically, the minimum corresponds to a generalization of the logical AND binary operator. Let us also note that it is possible to normalize these three benefits (before applying the minimum) to take account of the fact that they are based on various aggregation operators. This example illustrates the way in which the benefits are determined in a general manner over several aggregation levels on the basis of the benefits calculated over a single aggregation level.

To solve the problem posed, the invention proposes to construct an index ω_{A} which indicates the benefit to an alternative of improving itself in accordance with the coalition (set of criteria taken simultaneously) A of criteria. This notion of benefit should convey the fact that one desires a certain effectiveness in the enhancements. These indications depend on the evaluation function H as well as on the individual x. The benefit to the action x of improving itself in accordance with the coalition A of criteria for the grading system H is denoted ω_{A}(H,x).

We consider a set of n criteria. The scores of the action x in accordance with the n attributes will be denoted x₁, . . . xₙ. The partial degrees of satisfaction in accordance with the n criteria are denoted u₁, . . . , uₙ. We have uᵢ=uᵢ(xᵢ). For a coalition A of criteria, we denote by u_{A} the set of the scores of x obtained with regard to the criteria of the coalition A, and we denote by u_{N-A} the set of the scores of x obtained with regard to the criteria other than those of the coalition A. The benefit of self improvement ω_{A}(H,x) is concentrated on the influence of the aggregation function H. This is consistent with a multilevel approach in which the influence of each aggregation level is studied separately. At a certain level, one is interested in the influence of an improvement to the aggregate microcriteria at this level, on the degree of satisfaction arising from the aggregation of this level. The utility functions with regard to the grades xᵢ are of no concern here.

To simplify the explanations, we shall firstly examine the manner of obtaining the expression for the indicator ω_{A} without effort. The notion of benefit of self improvement should convey the fact that one desires a certain effectiveness in the enhancements that the alternative can effect. This requires account to be taken of the effort that the alternative will have to provide in order to achieve a certain improvement.

The construction of an indicator ω_{A} is not easy. The approach which comes to mind is to intuitively construct an expression for ω_{A}. One can then verify that this expression produces a good type of behavior with regard to a certain number of examples of aggregation functions. However, if one then wishes to use ω_{A} on other examples of aggregation functions, how can one be sure that good behavior will also be obtained? It is to answer this question that, according to the invention, the indicator ω_{A} has been constructed mathematically. The idea is then to determine the expression for ω_{A}(H,x) for any aggregation function H based on certain properties involving only a few very specific families of aggregation function. More precisely, the invention starts from a so-called axiomatic approach, that is to say one consisting in characterizing ω_{A}(H,x) by a series of properties that a decision maker would naturally allocate to the benefit of self improvement according to the coalition A of criteria. An approach of this type is used a great deal in decision theory, since it allows the decision maker to understand the properties characterizing the notion that one wishes to define, without going via the mathematical expression for this notion.

The natural properties that ω_{A} must satisfy will now be described. Certain ones of the set of decision attitudes that may arise are fairly extreme. Hence, we refer to the typical decision strategies. As an example of typical strategies, we have the phenomena of tolerance, intolerance and dictator. Most decision attitudes are to be found among the typical typical strategies and are constructed on the basis of these typical strategies. More precisely, since one is working on numerical scales, the decision attitudes H may be written in the form of linear combinations of typical strategies Hᵢ. These are in fact convex combinations in the sense that each typical attitude corresponds to a certain percentage of the overall decision taking strategy. A benefit of self improvement can be defined for each typical attitude. One then expects the benefit of self improvement according to the criteria of the coalition A for H to also be a linear combination (with the same weights) of the benefits of self improvement according to the criteria of the coalition A for the Hᵢ. Stated otherwise, the indicator should satisfy the following linearity property (L):

$$- if H is written in the form H = {\sum }_{i = 1}^{p} {α}_{i} {H}_{i} then$$

$${ω}_{A} ( H , x ) = {\sum }_{i = 1}^{p} {α}_{i} {ω}_{A} ( {H}_{i} , x ) .$$

The way in which H is determined in practice is always approximate. Thus, several functions H may transcribe the same expertise. These functions are close to one another. One should therefore ensure that the benefit of self improvement according to the criteria of the coalition A gives approximately the same result for all these aggregation functions.

The indicator ω_{A}(H) (x) should satisfy the property of continuity (C) with the respect to H:
(C): If H₁ and H₂ are two aggregation functions providing approximately the same values, then:
   ω_{A}(H₁,x) is close to ω_{A}(H₂,x).

The indicator accords no particular importance to one criterion with respect to another criterion. It should analyze H without a priori favoring a criterion. There should therefore be anonymity between the criteria.

The indicator should therefore satisfy the following symmetry property (S):
(S): If the order of the criteria in A, H and x is permutated in the same way, then:
   ω_{A}(H,x) should not change.

Let us consider the case of a function H(x) that does not depend on the values of x according to a coalition A of criteria. So, since the improvement of an alternative x in accordance with the criteria A brings no improvement in accordance with the overall score, it is completely useless to improve oneself in accordance with this coalition of criteria.

Thus, the benefit ω_{A}(H,x) should be zero (zero benefit property IN):
(IN): If the function H(x) does not depend on the values of x in accordance with the coalition A of criteria, then:
   ω_{A}(H,x)=0.

Let us consider the case of a function H that does not depend on a criterion i. In this case, the gain in the overall score that can be produced by self improvement in accordance with the coalition A of criteria is the same as that by self improvement in accordance additionally with criterion i. Since, in the present case, we are making the assumption that it costs no additional effort to work additionally in accordance with criterion i, then it is natural that ω_{A∪(i)}(H,x)=ω_{A}(H,x). The recursivity property (R) is then:
(R): Let A be a coalition of criteria and i a criterion not belonging to A. If the function H(x) does not depend on xᵢ, then:
   ω_{A∪(i)}(H,x)=ω_{A}(H,x)

Let us focus on a family of evaluation functions that are very intuitive. Let us consider the case where the decision maker is perfectly satisfied if the scores of an action lie between two given multidimensional thresholds α and β, and finds the action unacceptable in the converse case. This family is therefore composed of all the evaluations I_{α,β} indexed by α,β ε[0,1]ⁿ, with

$${I}_{α , β} ( x ) = \{ \begin{matrix} 1 , & if for all j , {u}_{j} ∈ [ {α}_{j} , {β}_{j} ] \\ 0 & otherwise\end{matrix}$$

The optimization of the function I_{α,β} corresponds to a constraints satisfaction problem in which there is a hard constraint (uᵢ ε[αⱼ, βⱼ]) per criterion. Let us also define, for λ, μ ε[0,1], the quantity J_{λ,μ}ⁱ(x) in the following manner

$${J}_{λ , μ}^{i} ( x ) = \{ \begin{matrix} 1 , & if {u}_{i} ∈ [ λ , μ ] \\ 0 & otherwise\end{matrix}$$

Let A be a coalition of criteria and x be such that uⱼ ε[αⱼ, βⱼ] for all j outside the coalition A. Then, the overall score I_{α,β}(x) is decomposed in accordance with each criterion of A in the following way:

$${I}_{α , β} ( χ ) {\prod }_{i ∈ A}^{} {J}_{{α}_{i} , {β}_{i}} ( x ) .$$

Each J_{α}_{ᵢ}_{,β}_{ᵢ}ⁱ(x) depends only on uᵢ. In this decomposition, there is independence between the different variables. On account of this, it is natural that the benefit ω_{A}(I_{α,β},x) should decompose in accordance with the benefits ωᵢ(J_{α}_{ᵢ}_{,β}_{ᵢ}ⁱ,x) for all the criteria i in the coalition A. The indicator should therefore satisfy the following decomposition property (D):
(D): Let x be such that uⱼ ε[αⱼ, βⱼ] for any j outside the coalition A. Then:
   ω_{A}(I_{α,β},x) is an aggregation of the ωᵢ(J_{α}_{,β}_{ᵢ}ⁱ,x) for all the criteria i in the coalition A.

The way in which the aggregation of the benefits is done is not specified in the decomposition property.

For the overall score Ji_{λ,λ+n}ⁱ(x), it is beneficial to improve the score xᵢ and to send it to yᵢ if uᵢ [λ,λ+η] and vᵢε[λ,λ+η] (vᵢ being the degree of satisfaction of yᵢ). For various values of λ, an alternative x always has the same chance of effecting an improvement that will be profitable, since the probability depends only the size η of the interval [λ,λ+η]. Thus, since we assume here that this requires no effort of self improvement, ωᵢ(J_{λ,λ+η}ⁱ,x) should not depend on λ. The indicator should therefore satisfy the following invariance property (I):
(I): for any λ,μ,η such that λ,λ+η,μ,μ+η≧uᵢ, then ωᵢ(J_{λ,λ+η}ⁱ,x)=ωᵢ(J_{μ,μ+η}ⁱ,x).

This property conveys the fact that an alternative, when it improves itself, has the same a priori probability of attaining any better ranked alternative.

The way in which to express ω_{A} will now be set forth. A few properties that it would be natural for ω_{A}(H,x) to have were set forth hereinabove. This leads to the following result R1:
Result R1: Let ω_{A} be an indicator satisfying the properties (L), (C), (S), (IN), (R), (D) and (I). Then ωA(H,x)≦ω_{A}^{\hat{ }}(H,x), with:

$${ω}_{A}^{⋀} ( H , x ) = {\int }_{0}^{1} [ H ( ( 1 - τ ) {u}_{A} + τ , {u}_{N - A} ) - H ( u ) ] ⅆ τ .$$

Moreover, ω_{A}^{\hat{ }} also satisfies the properties (L), (C), (S), (IN), (R) and (I).

Let us give an interpretation of the expression for ω_{A}^{\hat{ }}. The term H((1-τ)u_{A}+τ,u_{N-A})−H(u) corresponds to the gain obtained in the overall score when the alternative goes from the scores u_{A} in accordance with the coalition A to (1-τ)u_{A}+τ. The point (1-τ)u_{A}+τ lies on the diagonal between u_{A} and the alternative which is perfectly satisfactory everywhere (score 1 in all the criteria). Thus, ω_{A}^{\hat{ }} is the mean value on the diagonal of the gains obtained in the overall score. Computing the mean value on the diagonal signifies that one wants the student to improve himself uniformly in accordance with all the criteria of the coalition A.

We shall see that ω_{A}^{\hat{ }} corresponds to the case where the aggregator in the property (D) is fixed at the minimum function:
ECOMPOSITION*(D*): let x be such that uⱼ ε└αⱼ,βⱼ┘ for any j outside the coalition A. Then ω_{A}(I_{α,β}) (x) is the minimum of the ωᵢ(J_{α}_{ᵢ}_{,β}ⁱ,x) for all the criteria i in the coalition A.

ω_{A}^{\hat{ }} is characterized in the following manner:
Result R2: An indicator ω_{A} satisfies the properties (L), (C), (S), (IN), (R), (D*) and (I) if and only if ω_{A}(H,x)=ω_{A}^{\hat{ }}(H,x).

The indicator ω_{A}^{\hat{ }} is therefore the largest among all the admissible indicators (that is to say it satisfies the properties (L), (C), (S), (IN), (R), (D) and (I)) . It has been shown that all the admissible indicators are equal when A is a singleton. So, according to the result R1 given above, the indicator ω_{A}^{\hat{ }} therefore has the property of favoring the coalitions of more than one element. It is this indicator that characterizes the invention.

In the above account, we have obtained an expression for the benefit ωhd A when the notion of effort to be produced to improve oneself does not exist. Now, it is clear that it costs something to improve oneself. This has to be taken into account in order for the estimate of the effort ω_{A} to be realistic.

To express the indicator ω_{A} with effort, we denote by E_{A}((1-τ)x_{A}+τ,x) the effort to be provided in order to go from x_{A} to (1-τ)x_{A}+τ in accordance with the coalition A, the scores in accordance with the other criteria remaining at x_{N-A}. The generalization of ω_{A}^{\hat{ }} to the case where the effort must be taken into account becomes:

$${ω}_{A}^{⋀} ( H , x ) = {\int }_{0}^{1} \frac{H ( ( 1 - τ ) {u}_{A} + τ , {u}_{N - A} ) - H ( u )}{{E}_{A} ( ( 1 - τ ) {u}_{A} + τ , u )} ⅆ τ$$

The effort function can then be modeled in a similar manner to the aggregation function H, that is to say by basing it on phase 3 of the multiattribute utility theory described above. Nevertheless, when this effort cannot easily be modeled, the invention advocates the following choice for the effort function:

$${E}_{A} ( ( 1 - τ ) {u}_{A} + τ , u ) = τ {\sum }_{i ∈ A} ( 1 - {u}_{i} ) .$$

Once the indicators ω_{A} have been calculated for any coalition A of criteria, the instructor immediately deduces the student's weak points therefrom. The weak points to be improved as a priority are the criteria of the coalition A which maximizes ω_{A}. To show this in a practical way, we shall, for the sake of clarity, consider only the coalitions A which correspond to singletons. If A={i} is a coalition composed of a single criterion (criterion i in this instance), we denote by ωᵢ the benefit of self improvement in accordance with criterion i alone. The determination of the criterion i with regard to which it is on average more effective to improve oneself corresponds to the index i that maximizes ωᵢ. To show the application of the indicator ωᵢ, let us consider the case of a student evaluated through four criteria. Let us consider the student defined by the scores x1 to x4 (see FIG. 2):

The indications given by ωᵢ(H,x) with regard to a few typical exemplary aggregation functions:

When the aggregation function H is the minimum (intolerant decision maker), we obtain (see FIG. 3): ω₁, ω₃ and ω₄ are zero, while ω₂ is a maximum. This result is perfectly logical, since the overall score of x will only be able to rise if the score according to the poorest criterion of x (in the present case, this is the second criterion) increases. It is completely useless to work in accordance with the other criteria.

When the aggregation function H is the maximum (tolerant decision maker), we obtain (see FIG. 4): ω₃>ω₁>ω₄>ω₂. It is clear that with this aggregation function, it is beneficial for the action to improve itself as a priority in accordance with criterion 3 (that is to say with regard to its best criterion). Contrary to the “minimum” aggregation function, it is nevertheless beneficial to improve oneself in accordance with the other criteria.

The weighted sum S_{λ} is very often used as means of aggregation. It is written in the form S_{λ}(x)=λ₁x₁+λ₂xₓ+λ₃x₃+λ₄x₄. For this aggregation function, each criterion is independent of the others in the sense that the contribution of a criterion to the overall score does not depend on the scores of the other criteria. By taking the expression set forth hereinabove (indicator ω_{A} with effort) as expression for the effort, we obtain
ωᵢ(S_{λ},x)=λᵢ

Stated otherwise, it is beneficial for the student to improve himself as a priority with regard to the criterion of highest weight (that is to say the most important criterion), and to do so whatever his scores.

The indicator ωᵢ therefore provides the expected results with regard to these classical aggregation functions.

1. A process for aiding the proposal of improvements to at least part of the parameters governing a system with several input parameters and producing a result, characterized in that it consists in calculating a model which contains the partial criteria for evaluating a result, and represents the degree of satisfaction by hierarchizing the criteria in tree form, by calculating a utility function and by calculating an aggregation function to aggregate these partial criteria so as to be able to express an overall degree of satisfaction, in evaluating the result and in highlighting the weak points to be improved through action on at least part of the parameters.

2. The process as claimed in claim 1, wherein the system is a training simulator and that the result is a training schedule that the process is to optimize.

3. The process as claimed in claim 2, wherein to highlight the weak points to be improved, an indicator is used which depends on the aggregations and on the score of the student and which indicates the benefit of improving the result according to a coalition of criteria.

4. The process as claimed in claim 1, wherein the aggregations are done on several levels.

5. The process as claimed in claim 2, wherein the weak points to be worked on correspond to the coalition which maximizes the indicator.

6. The process as claimed in claim 1, wherein the indicator is an overall indicator which is obtained on the basis of the minima of partial indicators calculated at different levels of aggregation.

7. The process as claimed in claim 3, wherein the indicator must satisfy all the following properties: linearity, continuity, symmetry, zero benefit, recursivity, decomposition, invariance.

8. The process as claimed in claim 7, wherein the preferred indicator is the only one which additionally satisfies the Decomposition property.

9. The process as claimed in claim 2, wherein the aggregations are done on several levels.

10. The process as claimed in claim 3, wherein the aggregations are done on several levels.

11. The process as claimed in claim 3, wherein the weak points to be worked on correspond to the coalition which maximizes the indicator.

12. The process as claimed in claim 4, wherein the weak points to be worked on correspond to the coalition which maximizes the indicator.

13. The process as claimed in claim 2, wherein the indicator is an overall indicator which is obtained on the basis of the minima of partial indicators calculated at different levels of aggregation.

14. The process as claimed in claim 3, wherein the indicator is an overall indicator which is obtained on the basis of the minima of partial indicators calculated at different levels of aggregation.

15. The process as claimed in claim 4, wherein the indicator is an overall indicator which is obtained on the basis of the minima of partial indicators calculated at different levels of aggregation.

16. The process as claimed in claim 5, wherein the indicator is an overall indicator which is obtained on the basis of the minima of partial indicators calculated at different levels of aggregation.

17. The process as claimed in claim 4, wherein the indicator must satisfy all the following properties: linearity, continuity, symmetry, zero benefit, recursivity, decomposition, invariance.

18. The process as claimed in claim 5, wherein the indicator must satisfy all the following properties: linearity, continuity, symmetry, zero benefit, recursivity, decomposition, invariance.

19. The process as claimed in claim 6, wherein the indicator must satisfy all the following properties: linearity, continuity, symmetry, zero benefit, recursivity, decomposition, invariance.
